(19) United States
(12) Patent Application Publication
(10) Pub. No.: US 2007/0236968 A1
(43) Pub. Date: Oct. 11, 2007

(54) POWER SUPPLY WITH RIPPLE ATTENUATOR

(75) Inventors: Quan-Qing Wu, Shanghai (CN); Hong-Jian Gan, Shanghai (CN)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Delta Electronics, Inc., Taoyuan Hsien (TW)

(21) Appl. No.: 11/554,340

(22) Filed: Oct. 30, 2006

(30) Foreign Application Priority Data
Apr. 7, 2006 (TW) 095112511

(51) Int. Cl. H02M 1/12

(52) U.S. Cl. 363/39

(57) ABSTRACT

A power supply configured for converting an input AC voltage into an output DC voltage having a desired voltage level is provided. The power supply includes a front-end power converter such as a PFC converter which is configured to convert the input AC voltage into an intermediate DC voltage generated across an output capacitive unit, and a back-end power converter such as a DC-DC converter which is configured to convert the intermediate DC voltage into an output DC voltage having a desired voltage level. The power supply further includes a resonant network consisted of a filter which is made up of at least one inductive filtering element having an inductive impedance and a capacitive filtering element having a capacitive impedance. The resonant network is placed between the front-end power converter and the back-end power converter, and coupled with the output capacitive unit for filtering the current flowing into the output capacitive unit.

### FIELD OF THE INVENTION

The present invention is related to a power supply, and more particularly to a power supply with a ripple attenuator for reducing the ripple current flowing in an output capacitive element of the power supply.

### BACKGROUND OF THE INVENTION

Nowadays more and more restrict requirements are proposed on power supply which are mainly focus on high efficiency and high power density. For a power supply, its internal space is mainly occupied by passive components, such as heat sinks, inductors and capacitors. Thus the reduction of the passive components' volume is the key point to produce high power density power supply.

FIG. 1 shows a power supply 100 having a power factor correction (PFC) circuit being framed with a two-stage topology. The power supply 100 shown in FIG. 1 is made up of a boost PFC converter 102 and a DC-DC converter 104, in which the boost PFC converter 102 includes a bridge rectifier 110, a boost inductor L11, a transistor switch S11, and a diode D11. The bridge rectifier 110 is configured to rectify an input AC voltage Vin into a rectified DC voltage having a predetermined voltage level. The boost inductor L11 is coupled to an output terminal of the bridge rectifier 110, and configured to receive currents from the bridge rectifier 110 and transfer the stored energy to an output capacitive unit Cb through the diode D11 according to the on/off operations of the transistor switch S11. In FIG. 1, the output capacitive unit Cb is an electrolytic capacitor. It should be noted that the capacitive unit mentioned herein is termed as a storage element (such as an inductor or capacitor) connected in series or in parallel with a non-storage element (such as a resistor), if the impedance of such combination shows a capacitive characteristic within a certain frequency range. The definition of an inductive unit is given in a similar manner. For example, if the impedance of the combination of a storage element (such as an inductor or capacitor) and a non-storage element (such as a resistor) shows an inductive characteristic within a certain frequency range, such combination may be termed as an inductive unit. The transistor switch S11 is driven by a power factor correction control signal Vg. With the on/off operations of the transistor switch S11, the boost inductor L11 charges the output capacitive unit Cb with the energy stored therein, and thereby generating an intermediate DC voltage across the output capacitive unit Cb. The DC-DC converter 104 is connected to the PFC converter 102 through the output capacitive unit Cb, and configured to convert the intermediate DC voltage into an output DC voltage having a desired voltage level for use by a load (not shown). Among all the components of the power supply 100, the volume of the electrolytic capacitor Cb is one of the largest.

And as is well known in the art, the PFC converter 102 uses the on/off operations of the transistor switch to convert an AC voltage into a DC voltage. Thus, a low-frequency ripple current will be induced and flow in the output capacitive unit. Besides, high-frequency ripple current is also generated due to the high-frequency on/off operations of the transistor switch, and superimposed on the low-frequency ripple current. FIG. 2 shows the signal waveforms employed in the PFC converter 102, in which Vg denotes the power factor correction control signal for driving the transistor switch S11, i_{L} denotes the inductor current flowing in the boost inductor L11, and i_{Cb} denotes the ripple current flowing in the output capacitive unit Cb. FIG. 3 shows the characteristic curve of the rms (root-mean-square) value of the ripple current versus the input voltage in the circumstances that the PFC converter 102 is operating in critical continuous conduction mode with an output power of 90 W. As can be seen from FIG. 3, the rms value of the ripple current is 0.65 A when the input voltage is 90V.

Since the volume of the electrolytic capacitor Cb is affected greatly by the ripple current flowing through, the reduction of the ripple current will help so much on decreasing the size of Cb and furthermore increasing the power density of the power supply 100.

The invention present a ripple attenuation technique for reducing the ripple current flowing in an output capacitive element of the power supply.

### SUMMARY OF THE INVENTION

An object of the present invention is to provide a power supply having a PFC converter and a DC-DC converter, in which the power supply includes a ripple attenuator being placed between the PFC converter and the DC-DC converter and configured to reduce the ripple current flowing in an output capacitive unit between the PFC converter and the DC-DC converter.

Another object of the present invention is to provide a ripple attenuator for use in a power supply with a power factor correction configuration, in which the ripple attenuator is placed between a PFC converter and a DC-DC converter and configured to reduce the ripple current flowing in an output capacitive unit between the PFC converter and the DC-DC converter.

According to a broader aspect of the present invention, a power supply is provided which includes a power factor correction converter being configured to convert an AC voltage into an intermediate DC voltage, an output capacitive unit having a capacitive impedance connected to the power factor correction converter for generating the intermediate DC voltage, a DC-DC converter connected to the output capacitive unit and configured to convert the intermediate DC voltage into an output DC voltage having a desired voltage level, and a resonant network placed between the power factor correction converter and the DC-DC converter and connected to the output capacitive unit for filtering the currents flowing in the output capacitive unit.

According to a narrower aspect of the present invention, a ripple attenuator is deposited in a power supply formed by a front-end power factor correction converter and a back-end DC-DC converter, in which the ripple attenuator is configured to reduce the ripple current flowing in an output capacitive unit placed between the front-end power factor correction converter and the back-end DC-DC converter. The ripple attenuator includes a resonant network placed between the front-end power factor correction converter and the back-end DC-DC converter and connected to the output capacitive unit for filtering the current flowing in the output capacitive unit.

Now the foregoing and other features and advantages of the present invention will be best understood through the following descriptions with reference to the accompanying drawings, wherein:

### BRIEF DESCRIPTION OF THE DRAWINGS

FIG. 1 shows a power supply having a power factor correction configuration according to the prior art;

FIG. 2 shows the waveforms in the power factor correction converter 102 of FIG. 1;

FIG. 3 shows the characteristic curve for the rms value of the ripple current in the output capacitive unit versus the rms value of the input voltage when the power factor correction converter 102 of FIG. 1 operates in the critical continuous conduction mode with an output power of 90 W;

FIG. 4 shows the circuitry of a power supply according to a first embodiment of the present invention;

FIG. 5 shows the characteristic curve of the rms value of the ripple current under different inductance of the resonant inductor and different capacitance of the resonant capacitor;

FIGS. 6(A) and 6(B) shows the simulation results according to the present invention;

FIGS. 7(A) and 7(B) shows the experimental results according to the present invention;

FIG. 8 shows the circuitry of a power supply according to a second embodiment of the present invention;

FIG. 9 shows the circuitry of a power supply according to a third embodiment of the present invention; and

FIG. 10 shows the circuitry of a power supply according to a fourth embodiment of the present invention.

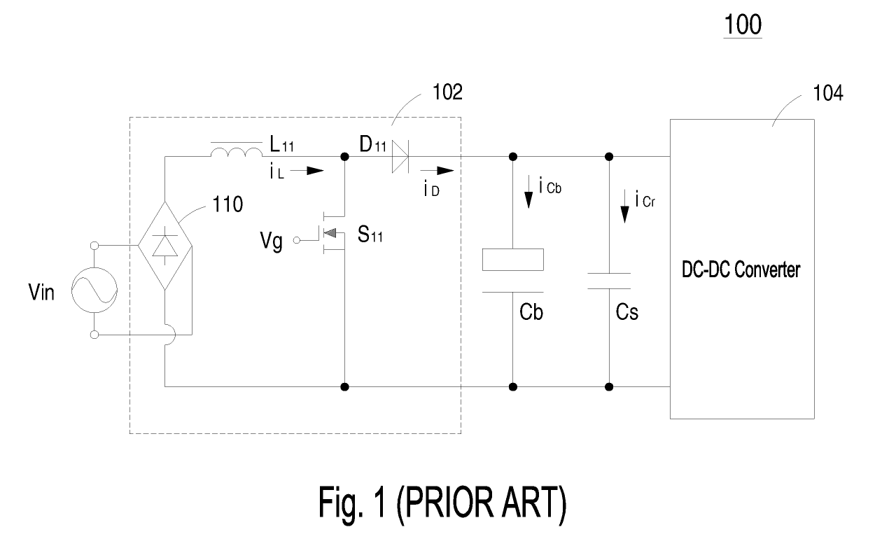

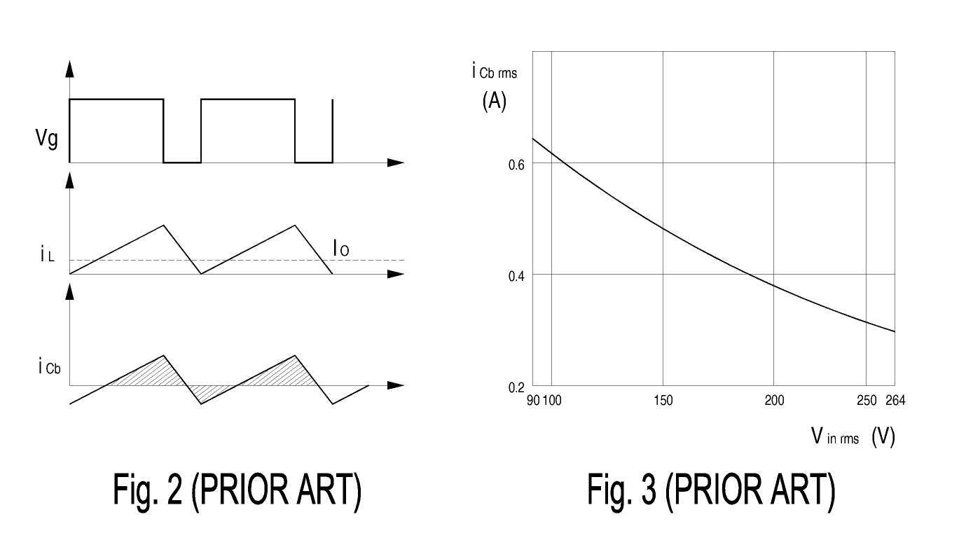

### DETAILED DESCRIPTION OF THE PREFERRED EMBODIMENT

Several preferred embodiment embodying the features and advantages of the present invention will be expounded in following paragraphs of descriptions. It is to be realized that the present invention is allowed to have various modification in different respects, none of which departs from the scope of the present invention, and the description herein and the drawings are to be taken as illustrative in nature, but not to be taken as limitative.

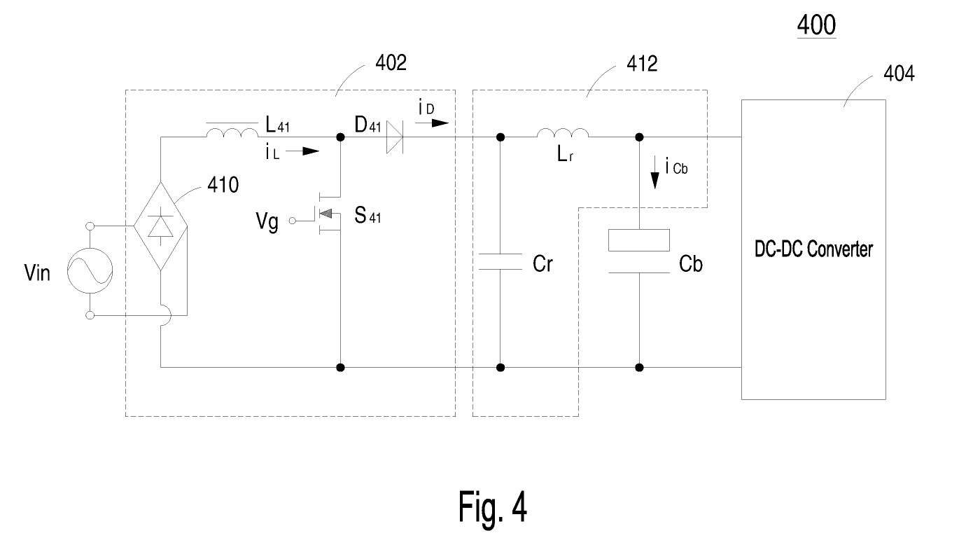

A first embodiment of the present invention is shown in FIG. 4. FIG. 4 shows the circuitry of a power supply 400 having a power factor correction (PFC) converter 402 and a DC-DC converter 404. The PFC converter 402 includes a bridge rectifier 410, a boost inductor L41, a transistor switch S41, and a diode D41. The bridge rectifier 410 is configured to rectify an input AC voltage Vin into a full-wave rectified DC voltage having a predetermined voltage level. The boost inductor L41 is connected to an output terminal of the bridge rectifier 410, and configured to receive currents from the bridge rectifier 410 and transfer the stored energy to an output capacitive unit Cb with capacitive impedance through the diode D41 according to the on/off operations of the transistor switch S41. The transistor switch S41 is driven by a PFC control signal Vg. With the on/off operations of the transistor switch S41, the boost inductor L41 may charge the output capacitive unit Cb with the energy stored therein, and thereby generating an intermediate DC voltage across the output capacitive unit Cb. The DC-DC converter 404 is connected to the PFC converter 402 through the output capacitive unit Cb, and configured to convert the intermediate DC voltage into an output DC voltage having a desired voltage level for use by a load (not shown).

In FIG. 4, a resonant network 412 formed by an inductive filtering unit Lr having inductive impedance and a capacitive filtering unit Cr having capacitive impedance acts as a ripple attenuator for reducing the ripple current flowing in the output capacitive unit Cb. The resonant network 412 is placed between the PFC converter 402 and the DC-DC converter 404 and connected to the output capacitive unit Cb. The resonant network 412 is a filter device in which the capacitive filtering unit Cr is a high-frequency capacitor having a smaller equivalent series resistance (ESR). The capacitive filtering unit Cr is connected between the PFC converter 402 and the output capacitive unit Cb and connected in parallel with the output capacitive unit Cb, and the inductive filtering unit Lr is connected between the capacitive filtering unit Cr and the output capacitive unit Cb. The resonant network 412 is configured to allow the low-frequency ripple current to flow in the output capacitive unit Cb and suppress the high-frequency ripple current flowing in the output capacitive unit Cb.

The operation of the circuitry shown in FIG. 4 is illustrated as follows. When the transistor switch S41 is turned on, the boost inductor L41 receives an AC current from the bridge rectifier 410 and thus stores energy therein. When transistor switch S41 is turned off, the boost inductor L41 releases the stored energy by an inductor current i_{L}, in which a portion of the inductor current i_{L} is provided to the back-end DC-DC converter 404 and a portion of the inductor current i_{L} is provided to flow in the resonant network 412 and the output capacitive unit Cb. Due to the low equivalent impedance of the capacitive filtering unit Cr, among the portion of the i_{L} flowing in the resonant network 412 and Cb, the majority flows in the capacitive filtering unit Cr. Also, due to the high equivalent impedance of the circuit branch formed by the inductive filtering unit Lr and the output capacitive unit Cb, the minority flows in the filtering unit Lr and the output capacitive unit Cb. Thus, the ripple current flowing in the output capacitive unit Cb is reduced, and also the high-frequency voltage ripple generated across the output capacitive unit Cb is reduced as well.

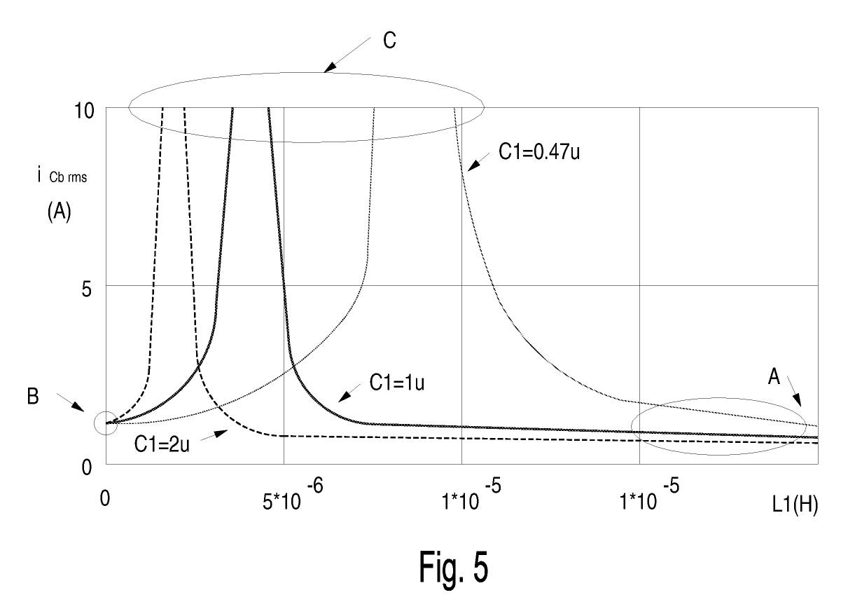

If it is desired to achieve an efficient performance on ripple attenuation, the parameters of the resonant network 412 have to be appropriately selected. FIG. 5 shows the characteristic curve of the rms value of the ripple current compiled under different inductance L1 of the resonant inductor Lr and different capacitance C1 of the resonant capacitor Cr. It can be seen from FIG. 5 that if the value of the inductance L1 and the setting of the capacitance C1 are both relatively large (located at the points within the enclosed region A), which makes the resonant frequency

$${f}_{1} = \frac{1}{2 \cdot π \cdot \sqrt{{L}_{1} \cdot {C}_{1}}}$$

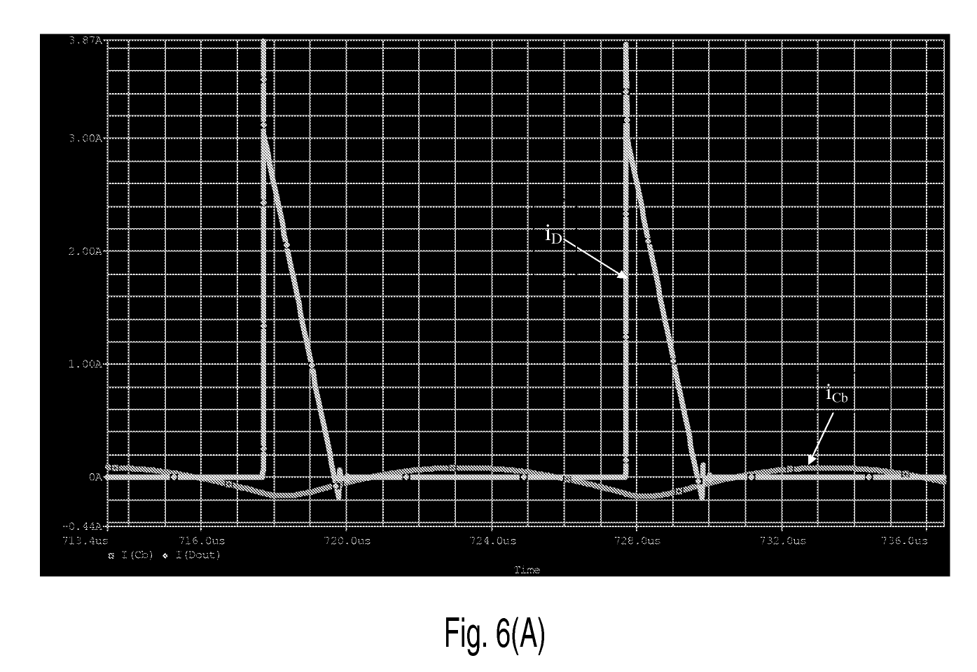

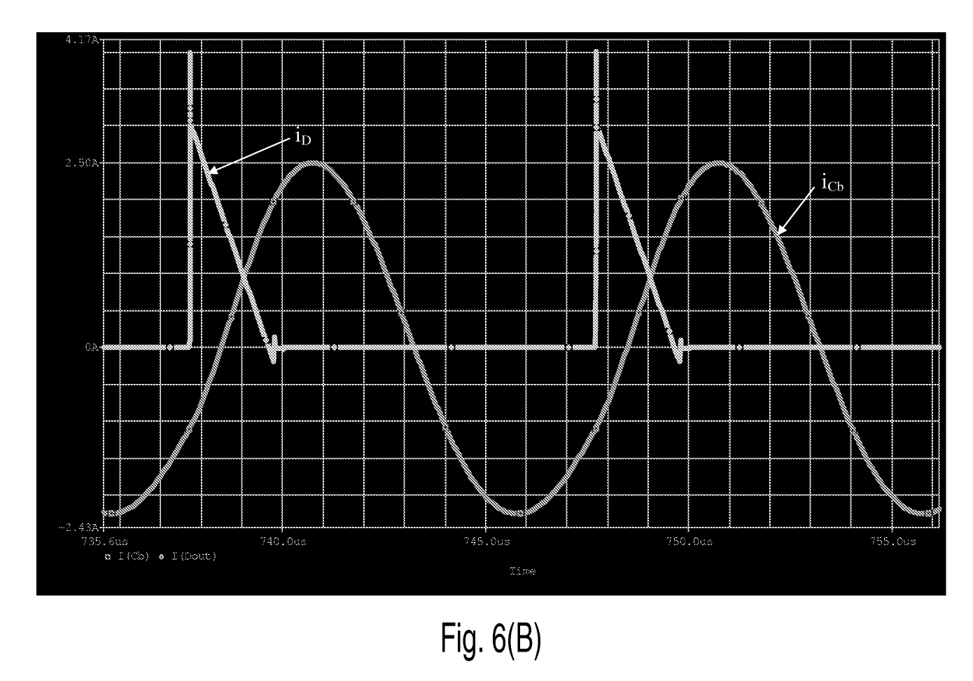

of the resonant network 412 will be lower than the minimum switching frequency, thus the rms value of the ripple current flowing in the output capacitive unit Cb will be lower than that flowing in the output capacitive unit Cb when the inductance L1 is zero (located at the points within the enclosed region B). When the setting of the inductance L1 and the setting of the capacitance C1 are located at the points within the enclosed region C, the rms value of the ripple current flowing in the output capacitive unit Cb will be very large. FIGS. 6(A) and 6(B) are the simulation results obtained on the condition that the parameters of the resonant network are appropriately selected (located at region A) and those are not appropriately selected (located near to region C and away from region A), respectively. As shown in FIGS. 6(A) and 6(B), the waveform of the ripple current i_{Cb} flowing in the output capacitive unit Cb and the waveform of the current i_{D} flowing in the diode D41 are depicted.

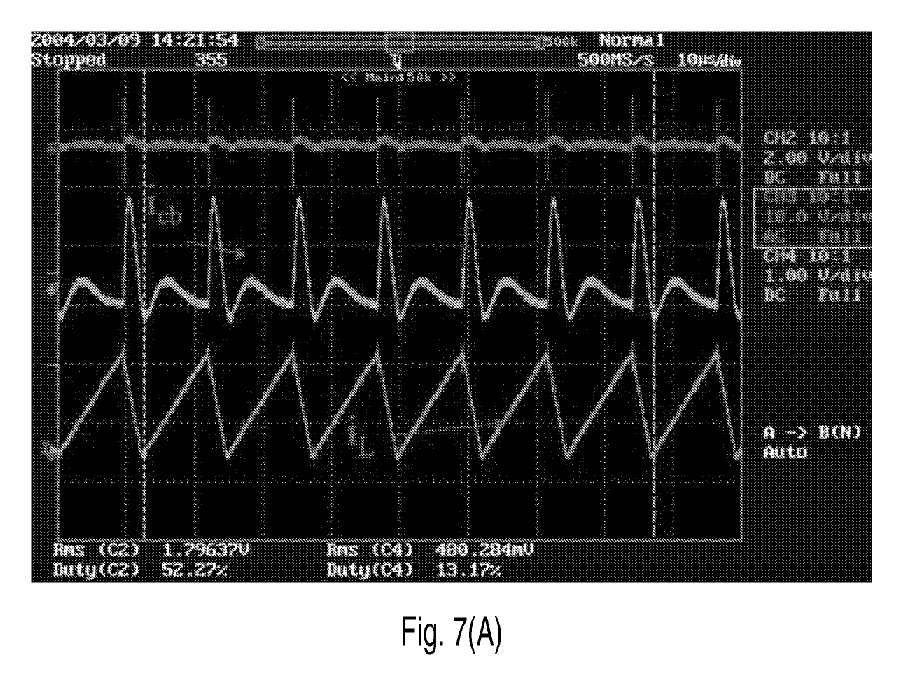

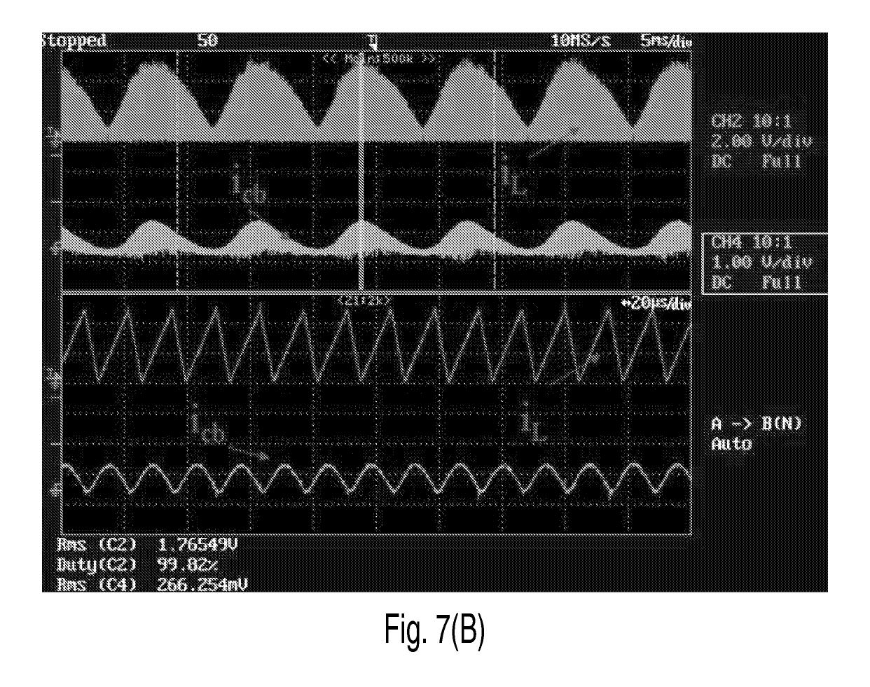

FIGS. 7(A) and 7(B) are the experimental results in the circumstances that the PFC converter 402 is working in the critical continuous conduction mode with an input voltage around 150V and an output power of 90 W. FIG. 7(A) indicates that the ripple current flowing in the output capacitive unit Cb will be 0.48 A when the capacitance of the output capacitive unit Cb is 36 μF and the inductance of the inductor Lr and the capacitance of the capacitor Cr are respectively 0 μH and 1 μF. FIG. 7(B) indicates that the ripple current flowing in the output capacitive unit Cb will be reduced to 0.27 A when Cb is 36 μF and Lr and Cr are 15 μH and 1 μF, respectively. When the circuit is working in continuous conduction mode or discontinuous conduction mode, the ripple current flowing in the output capacitive unit Cb will be dramatically reduced through the use of the ripple reduction technique of the present invention.

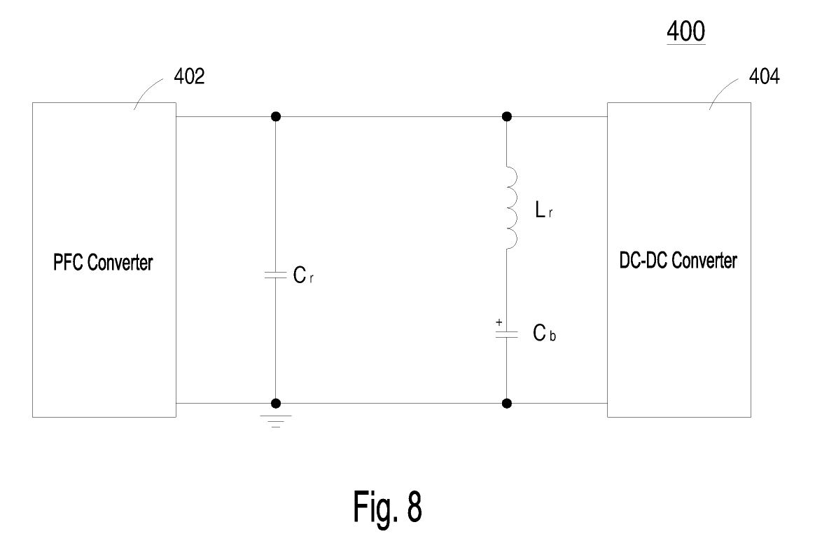

FIG. 8 shows the circuitry of a power supply according to a second embodiment of the present invention. In FIG. 8, the inductive filtering unit (indicated by the inductor Lr shown in the diagram) is connected in series with the output capacitive unit (indicated by the capacitor Cb shown in the diagram). Thus, the resonant network formed by the inductive filtering unit Lr and the capacitive filtering unit Cr not only can reduce the ripple current originated from the front-end PFC converter 402, but also can reduce the ripple current of the back-end DC-DC converter 404.

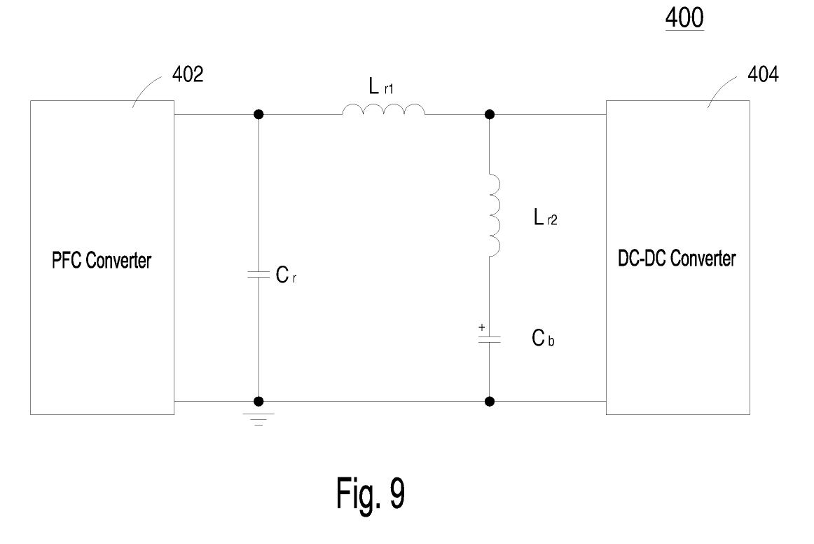

FIG. 9 shows the circuitry of a power supply according to a third embodiment of the present invention. The circuitry of FIG. 9 is derived by replacing the inductive filtering unit Lr of FIG. 4 with a center-tapped inductive element. Therefore, the inductive filtering unit of FIG. 9 is implemented by tap inductors Lr1 and Lr2, in which the first tap inductor Lr1 is connected between the capacitive filtering unit Cr and the output capacitive unit Cb and the second tap inductor Lr2 is connected in series with the output capacitive unit Cb. The circuitry of FIG. 9 not only combines the advantages offered by the first embodiment and the second embodiment of the present invention, but also allows the location of the tap in the inductors to be optimally allocated according to different parameter settings of the inductor. Another possible circuitry modified from the circuitry of FIG. 8 can be made by replacing the tap inductors with a coupled inductor.

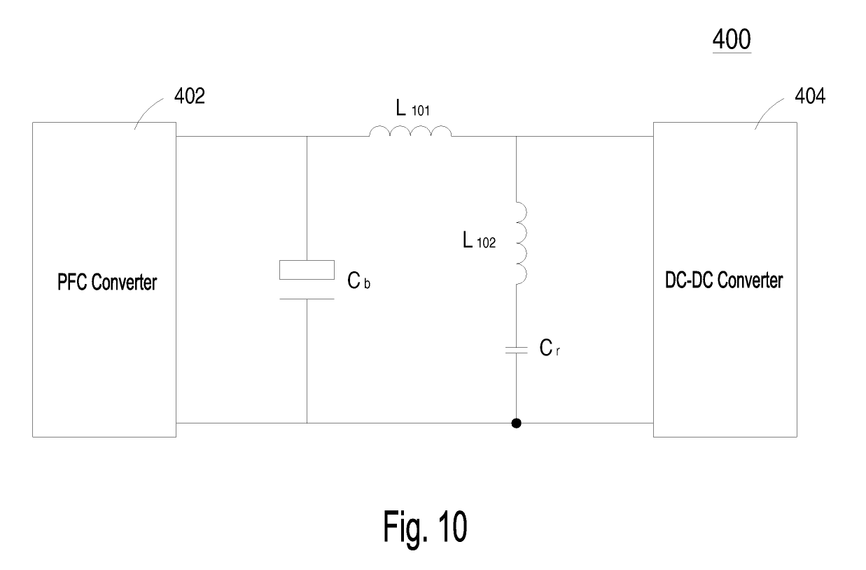

FIG. 10 shows the circuitry of a power supply according to a fourth embodiment of the present invention. The resonant network shown in FIG. 10 is configured to reduce the ripple current originated from the front-end PFC converter 402 and the ripple current originated from the back-end DC-DC converter 404. The resonant network shown in FIG. 10 includes a capacitive filtering unit Cr connected between the DC-DC converter 404 and the output capacitive unit Cb and connected in parallel with the output capacitive unit Cb, a first inductive filtering unit L101 connected between the capacitive filtering unit Cr and the output capacitive unit Cb, and a second inductive filtering unit L102 connected in series with the capacitive filtering unit Cr. With the circuitry of FIG. 10, the circuit branch formed by the first inductive filtering unit L101, the second inductive filtering unit L102, and the capacitive filtering unit Cr constitutes a low-impedance current path for reducing the ripple current of the front-end PFC converter 402 when the resonant frequency fs1 of L101, L102 and Cr is close to the frequency of the harmonic current from the PFC converter stage which is needed to be reduced, wherein

$$fs 1 = \frac{1}{2 \cdot π \cdot \sqrt{L 101 + L 102 ) \cdot Cr}} .$$

Also, the circuit branch formed by the second inductive filtering unit L102 and the capacitive filtering unit Cr constitutes a low-impedance current path for reducing the ripple current of the back-end DC-DC converter 404 when the resonant frequency fs2 of L102 and Cr is close to the harmonic current frequency from the DC-DC converter stage which is needed to be reduced, wherein

$$fs 2 = \frac{1}{2 \cdot π \cdot \sqrt{L 102 \cdot Cr}} .$$

### Therefore, the ripple currents flowing in the output capacitive unit Cb can be dramatically reduced.

The front-end converters in the above preferred embodiment are boost PFC circuits, which output high ripple current. In fact, the front-end converter can also supply low ripple current source, such as a buck converter, while the back-end converter pulls pulse ripple current from the front-end converter, such as an asymmetrical half bridge (AHB) converter. The resonant network can also be applied in this kind of structure to reduce the ripple current flowing through the output capacitive unit connected between the front-end and the back-end converter.

In conclusion, the present invention contrives a ripple attenuator being placed between a front-end power converter and a back-end power converter and connected to an output capacitor. The ripple attenuator according to the present invention is configured as a resonant network including inductors and capacitors for filtering the current flowing in the output capacitor, and further reducing the ripple current of the output capacitor. With the ripple reduction technique disclosed herein, the ripple current existed in the power supply can be effectively suppressed without the need of a bulky capacitive element. Therefore, the voltage ripple can be reduced and the reliability of the power supply can be enhanced.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

What is claimed is:

1. A power supply comprising:
a front-end power converter configured to receive an input voltage and convert the input voltage into an intermediate voltage, wherein the front-end power converter having at least one operating frequency;
an output capacitive unit having a capacitive impedance and connected to the front-end power converter for generating the intermediate voltage;
a back-end power converter connected to the output capacitive unit and configured to receive the intermediate voltage and convert the intermediate voltage into an output voltage having a desired voltage level; and
a resonant network placed between the front-end power converter and the back-end power converter and connected to the output capacitive unit for filtering current flowing in the output capacitive unit, wherein the resonant frequency of said resonant network is lower than the operating frequency of the front-end power converter.

2. The power supply according to claim 1 wherein the resonant network comprises:
a capacitive filtering unit having a capacitive impedance connected between the front-end power converter and the output capacitive unit and connected in parallel with the front-end power converter; and
an inductive filtering unit having an inductive impedance connected between the capacitive filtering unit and the output capacitive unit;
wherein the output capacitive unit is connected in parallel with the back-end power converter.

3. The power supply according to claim 1 wherein the resonant network comprises:
a capacitive filtering unit having a capacitive impedance connected between the front-end power converter and the output capacitive unit and connected in parallel with the front-end power converter; and
an inductive filtering unit having an inductive impedance connected in series with the output capacitive unit;
wherein the series circuit formed by the inductive filtering unit and the output capacitive unit is connected in parallel with the front-end power converter and the back-end power converter.

4. The power supply according to claim 1 wherein the resonant network comprises:
a capacitive filtering unit having a capacitive impedance connected between the front-end power converter and the output capacitive unit and connected in parallel with the front-end power converter;
a first inductive filtering unit having an inductive impedance connected in series with the output capacitive unit; and
a second inductive filtering unit having an inductive impedance connected between the capacitive filtering unit and a series circuit formed by the first inductive filtering unit and the output capacitive unit;
wherein the series circuit formed by the first inductive filtering unit and the output capacitive unit is connected in parallel with the back-end power converter.

5. The power supply according to claim 4 wherein the first inductive filtering unit and the second inductive filtering unit form a coupled inductive element.

6. The power supply according to claim 1 wherein the front-end power converter is a power factor correction converter and the back-end power converter is a DC-DC converter.

7. The power supply according to claim 6 wherein the resonant network comprises:
a capacitive filtering unit having a capacitive impedance connected between the front-end power converter and the output capacitive unit and connected in parallel with the front-end power converter; and
an inductive filtering unit having an inductive impedance connected between the capacitive filtering unit and the output capacitive unit;
wherein the output capacitive unit is connected in parallel with the back-end power converter.

8. The power supply according to claim 7 wherein the capacitive filtering unit is a high-frequency capacitor, the output capacitive unit is an electrolytic capacitor, and the inductive filtering unit is an inductor.

9. The power supply according to claim 6 wherein the resonant network comprises:
a capacitive filtering unit having a capacitive impedance connected between the front-end power converter and the output capacitive unit and connected in parallel with the front-end power converter; and
an inductive filtering unit having an inductive impedance connected in series with the output capacitive unit;
wherein the series circuit formed by the inductive filtering unit and the output capacitive unit is connected in parallel with the front-end power converter and the back-end power converter.

10. The power supply according to claim 9 wherein the capacitive filtering unit is a high-frequency capacitor, the output capacitive unit is an electrolytic capacitor, and the inductive filtering unit is an inductor.

11. The power supply according to claim 6 wherein the resonant network comprises:
a capacitive filtering unit having a capacitive impedance connected between the front-end power converter and the output capacitive unit and connected in parallel with the front-end power converter;
a first inductive filtering unit having an inductive impedance connected in series with the output capacitive unit; and
a second inductive filtering unit having an inductive impedance connected between the capacitive filtering unit and a series circuit formed by the first inductive filtering unit and the output capacitive unit;
wherein the series circuit formed by the first inductive filtering unit and the output capacitive unit is connected in parallel with the back-end power converter.

12. The power supply according to claim 11 wherein the capacitive filtering unit is a high-frequency capacitor, the output capacitive unit is an electrolytic capacitor, and the first inductive filtering unit and the second inductive filtering unit are both an inductor.

13. The power supply according to claim 11 wherein the first inductive filtering unit and the second inductive filtering unit form a coupled inductive element.

14. A power supply comprising:
a front-end power converter configured to receive an input voltage and convert the input voltage into an intermediate voltage, wherein the front-end power converter having at least one operating frequency;
an output capacitive unit having a capacitive impedance and connected to the front-end power converter for generating the intermediate voltage;
a back-end power converter connected to the output capacitive unit and configured to receive the intermediate voltage and convert the intermediate voltage into an output voltage having a desired level; and
a resonant network placed between the front-end power converter and the back-end power converter and connected to the output capacitive unit for filtering a current flowing in the output capacitive unit, wherein the resonant network comprises:
a capacitive filtering unit having a capacitive impedance connected between the back-end power converter and the output capacitive unit;
a first inductive filtering unit having an inductive impedance connected in series with the capacitive filtering unit; and
a second inductive filtering unit having an inductive impedance connected between the output capacitive unit and a series circuit formed by the first inductive filtering unit and the capacitive filtering unit;
wherein the series circuit formed by the first inductive filtering unit and the capacitive filtering unit is connected in parallel with the back-end power converter, and the output capacitive unit is connected in parallel with the front-end power converter.

15. The power supply according to claim 14 wherein the front-end power converter is a power factor correction converter and the back-end power converter is a DC-DC converter.

16. The power supply according to claim 15 wherein the capacitive filtering unit is a high-frequency capacitor, the output capacitive unit is an electrolytic capacitor, and the first inductive filtering unit and the second inductive filtering unit are both an inductor.

17. A ripple attenuator for a power supply having a front-end power converter and a back-end power converter, wherein the ripple attenuator is configured to reduce a ripple current flowing in an output capacitive unit connected between the front-end power converter and the back-end power converter, the ripple attenuator comprising:
a resonant network placed between the front-end power converter and the back-end power converter and connected to the output capacitive unit for filtering a current flowing in the output capacitive unit;
wherein the back-end power converter having at least one operating frequency and the resonant frequency of the resonant network is lower than the operating frequency of the back-end power converter.

18. The ripple attenuator according to claim 17 wherein the resonant network at least includes a capacitive filtering unit having capacitive impedance and an inductive filtering unit having inductive impedance.

19. The ripple attenuator according to claim 18 wherein the capacitive filtering unit is a high-frequency capacitor, the output capacitive unit is an electrolytic capacitor, and the inductive filtering unit is an inductor.

20. The ripple attenuator according to claim 18 wherein the capacitive filtering unit having a capacitive impedance of the resonant network connected between the back-end power converter and the output capacitive unit and connected in parallel with the back-end power converter; and
the inductive filtering unit having an inductive impedance of the resonant network connected between the capacitive filtering unit and the output capacitive unit;
wherein the output capacitive unit is connected in parallel with the front-end power converter.
